(19) United States
(12) Patent Application Publication
(10) Pub. No.: US 2017/0277853 A1
(43) Pub. Date: Sep. 28, 2017

(54) DATA-DRIVEN PERFORMANCE BASED SYSTEM FOR ADAPTING ADVANCED EVENT DETECTION ALGORITHMS TO EXISTING FRAMEWORKS

(71) Applicant: Koninklijke Philips N.V., Eindhoven (NL)

(72) Inventors: Eric Thomas CARLSON, New York, NY (US); Larry James ESHELMAN, Ossining, NY (US)

(21) Appl. No.: 15/528,564

(22) PCT Filed: Dec. 14, 2015
(86) PCT No.: PCT/IB2015/059585

§ 371 Date: May 22, 2017

Related U.S. Application Data
(60) Provisional application No. 62/091,674, filed on Dec. 15, 2014.

(51) Int. Cl. G06F 19/00

(52) U.S. Cl. CPC G06F 19/3418; G06F 19/3431

(57) ABSTRACT

An early warning system for patient monitoring includes one or more patient monitors (620) configured to generate patient physiological data, a patient database (602) storing patient physiological measurements and outcomes, and one or more computer processors (604) programmed to: machine learn an Aggregate Weighted Track and Trigger System (AWTTS) algorithm for quantifying patient condition by an AWTTS score based on a training set of the patient physiological measurements and outcomes; apply an Early Warning Score or Modified Early Warning Score (EWS) algorithm to patient physiological measurements to generate EWS scores; apply the machine-learned AWTTS algorithm to the patient physiological measurements to generate AWTTS scores; and create a mapping between the AWTTS scores and the EWS scores.

### FIELD

The following relates generally to the medical monitoring arts. It finds particular application with medical warning systems that warn of deterioration of a monitored patient and will be described with particular reference thereto. However, the present disclosure will find applications in other areas as well.

### BACKGROUND

Patient deterioration is a large problem in hospitals. It is widely recognized that early detection of such deterioration can enable interventions that can prevent the deterioration from worsening and in turn can improve patient care. Hospitals, nursing homes, and other medical facilities commonly use a clinically oriented system designed to provide predictive information as to whether a given patient is likely to need emergency care, such as being admitted to an intensive care unit (ICU) or cardiac care unit (CCU). Many systems have been developed to aid in this detection, for example the Early Warning Score (EWS), the Modified Early Warning Score (MEWS), and other related systems, more generally referred to as Aggregate Weighted Track and Trigger Systems (AWTTS). Many hospitals have developed action plans that are designed around the chosen AWTTS. These action plans specify recommended actions for care providers to initiate in response to levels of patient deterioration, as reflected by the AWTTS score in use. Examples may be “Increase monitoring above an MEWS score of 3” or “Contact Physician above a MEWS score of 4.” Such scoring systems are developed using either physician consensus or data mining on large patient measurement databases. Once developed, the systems are deployed to hospitals to use as-is.

Current systems calculate the patient score from a look up table. For example, a patient's vital signs may be displayed and for each vital sign value, points are assigned based upon deviations from set points, e.g. normal. To generate the patient score, the total number of points are added together and, based upon a predetermined threshold, if the resulting point value is higher (or, in some designs, lower) than the recommended threshold, an alarm is issued to the medical personal. The assigned scores are intended to be quick look-ups for nurses and other medical personnel that trigger specific responses. However, these EWS systems are not standardized across hospitals, and the consensus for the action trigger is not standardized. To illustrate, in some instances, the score may range from 0 to 5 and in others it may range from 0 to 10.

Current deterioration detection systems are also recognized to have many deficiencies in performance, resulting in a large number of false positive or false negative determinations, which increase health care cost and reduce quality. Much of this performance problem can be a result of a poor match between the original training data (either initial training set for data mining, or physician consensus) and the hospital in which the resultant system has been deployed. Such mismatch can result from various differences between the setting in which the training data were acquired and the hospital of deployment, such as: differences in available equipment; differences in staffing levels; differences in medical training; differences in the served demographic distributions; and so forth. In an attempt to reduce the number of false positives, hospitals can adjust the standard system, but do not generally have the technical research staff necessary to do so in a way that does not compromise the sensitivity of the systems. A large impediment to any potential replacement system, however, is the inertia behind existing systems. Generations of physicians and nurses have been trained on the interpretation and use of existing AWTTS scores, and the defined action plans are the results of often years of consensus building around the appropriate responses to levels of patient deterioration. Many algorithms have been proposed that show demonstrably improved performance over the current generation of detection systems, but market uptake is hampered due to the infrastructure that would need to be created at each hospital site (e.g. training of care givers and definition of new action plans).

### SUMMARY

In accordance with one aspect, an early warning system for patient monitoring is disclosed. The early warning system comprises one or more patient monitors configured to generate patient physiological data, a patient database storing patient physiological measurements and outcomes, and one or more computer processors programmed to: machine learn an Aggregate Weighted Track and Trigger System (AWTTS) algorithm for quantifying patient condition by an AWTTS score based on a training set of the patient physiological measurements and outcomes; apply an Early Warning Score or Modified Early Warning Score (EWS) algorithm to patient physiological measurements to generate EWS scores; apply the machine-learned AWTTS algorithm to the patient physiological measurements to generate AWTTS scores; and create a mapping between the AWTTS scores and the EWS scores.

In accordance with another aspect an early warning method for patient monitoring is disclosed. The early warning method comprises: applying an Early Warning Score or Modified Early Warning Score (EWS) algorithm to patient physiological measurements to generate EWS scores quantifying patient condition; applying an Aggregate Weighted Track and Trigger System (AWTTS) algorithm to the patient physiological measurements to generate AWTTS scores quantifying patient condition; and creating a mapping between the AWTTS scores and the EWS scores. The applying operations and the creating operation are suitably performed by an electronic data processing device.

In accordance with another aspect a non-transitory storage medium stores instructions readable and executable by a computer to perform a method comprising: performing machine learning to generate an Aggregate Weighted Track and Trigger System (AWTTS) algorithm for quantifying patient condition by an AWTTS score wherein the machine learning is performed on a training set of the patient physiological measurements and outcomes and trains the AWTTS algorithm to optimally predict an outcome given a set of patient physiological measurements; applying the machine-learned AWTTS algorithm to patient physiological measurements of a current patient to generate an AWTTS score for the current patient; and displaying one of (1) the AWTTS score for the current patient and (2) the AWTTS score for the current patient mapped to a different early warning scoring algorithm.

One advantage resides in improving effectiveness and accuracy of a patient monitor in conveying a patient's risk.

Another advantage resides in better allocation of hospital resources such as assigning resources to higher risk patients.

Another advantage resides in reducing additional training for staff to migrate from a known and used patient detection system to a new patient detection system.

Another advantage resides in reducing staff confusion and potential mistakes when scoring systems are improved or replaced.

Still further advantages of the present invention will be appreciated to those of ordinary skill in the art upon reading and understand the following detailed description. It is to be appreciated that none, one, two, or more of these advantages may be achieved by a particular embodiment.

### BRIEF DESCRIPTION OF THE DRAWINGS

The invention may take form in various components and arrangements of components, and in various steps and arrangement of steps. The drawings are only for purposes of illustrating the preferred embodiments and are not to be construed as limiting the invention.

FIG. 1 is a schematic illustrating an overview of a medical institution and user input to a system to create a custom event detection system tailored for a hospital's patient population and event interest.

FIG. 2 illustrates a flowchart with a medical institution and user input combined with user feedback to select relevant features to generate a refined detection system.

FIG. 3 illustrates a flowchart with user selections for output format to generate a tailored detection system.

FIG. 4 is an illustrative example of one embodiment using conditional probability equivalence to map a new EWS system to an existing system.

FIG. 5 illustrates a system for incorporating an EWS system into an existing system is illustrated.

### DETAILED DESCRIPTION

Disclosed herein are improved patient monitoring systems and methods that improve the use of Aggregate Weighted Track and Trigger Systems (AWTTS)by medical personnel to guide a non-expert user in the creation of an event detection system tailored for a specific institution's care practices and patient population as well as creating a mapping between a new AWTTS output score and existing AWTTS output scores used at a particular institution. For illustration, the Early Warning Score (EWS) or Modified EWS (MEWS) is used herein, but the disclosed approaches can be readily applied in the context of any AWTTS scoring system.

The present system and methods can be used in a variety of institutions such as hospitals, hospital and patient care systems, clinics, nursing homes, and the like. Accordingly, “hospital” is used in the following for simplicity of discussion, but the term “hospital” as used herein is to be understood as including all such medical institutions.

By way of illustration, an example action plan for a modified early warning score (MEWS) detection system and associated action triggering plan is described. The action plan is generated based upon the calculation of a total number of points. The points are added together and based upon a predetermined threshold, if the resulting point value is higher or lower than the recommended threshold, an alarm is issued to the medical personal. The assigned scores are intended to be quick look ups for nurses and other medical personal that triggers a specific response.

As detailed in TABLE 1 below, an example Modified Early Warning System (MEWS) is described. The MEWS computes a score based on physiological parameters including: blood pressure; heart rate; respiration rate; patient temperature; and level of consciousness (for example, quantified using the AVPU scale, an acronym from “alert, voice, pain, unresponsive”). In MEWS, each of these physiological parameters has a normal range with score zero, and the score component for the physiological parameter increases as the value moves further out of the normal range. By way of illustration, a heart rate in the normal range of 51-100 beats per minute (BPM) scores zero, while a rate of between 41-50 or 101-110 BMP scores 1, a rate of less than 40 or between 111-129 BPM scores 2, and a rate of greater than 130 BPM scores 3. The AVPU scores 0 for “alert,” 1 for “voice response,” 2 for “pain response,” and 3 for “unresponsive.” The scores for the physiological parameters are totaled, and a score greater than a threshold, e.g. 5, is considered an action trigger (for example, triggering an emergency medical team call, triggering transfer to ICU or CCU, et cetera).

TABLE 1
Example Modified Early Warning System

| MEWS | |
|---|---|
| Score | Action triggered by score |
| 0-2 | Continue routine monitoring per adult patient standards of care |
| 3 | Increase vital signs and level of consciousness (LOC) frequency |
| | and include O₂ Saturation |
| | RN will perform focused assessment and if warranted will notify |
| | provider for possible transfer to higher level of care |
| | Review chart for severe sepsis |
| | Ensure verbal communication with health care team |
| 4 | Increase vital signs and level of consciousness (LOC) frequency |
| | and include O₂ Saturation |
| | RN will perform focused assessment and if warranted will notify |
| | provider for possible transfer to higher level of care |
| | Review chart for severe sepsis |
| | Document strict I & O |
| | Notify provider if UO <0.5 ml/kg/hr times 4 hours |
| | Ensure verbal communication with health care team |
| 5 | Increase vital signs and level of consciousness (LOC) frequency |
| | and include O₂ Saturation |
| | RN will perform focused assessment and inform RN manager or |
| | designee. Call Rapid Response Team (RRT) if applicable. |
| | If warranted, RN will notify provider for possible transfer to |
| | higher level of care |
| | Review chart for severe sepsis |
| | Document strict I & O |
| | Notify provider if UO <0.5 ml/kg/hr times 4 hours |
| | Ensure verbal communication with health care team |
| 6 | Verify vital signs and level of consciousness (LOC) |
| | RN will perform focused assessment and notify RN manager or |
| | designee |
| | Call Rapid Response Team (RRT) or Code Blue |
| | RN will notify provider for possible transfer to higher level of |
| | care. |
| | Ensure verbal communication with health care team. |

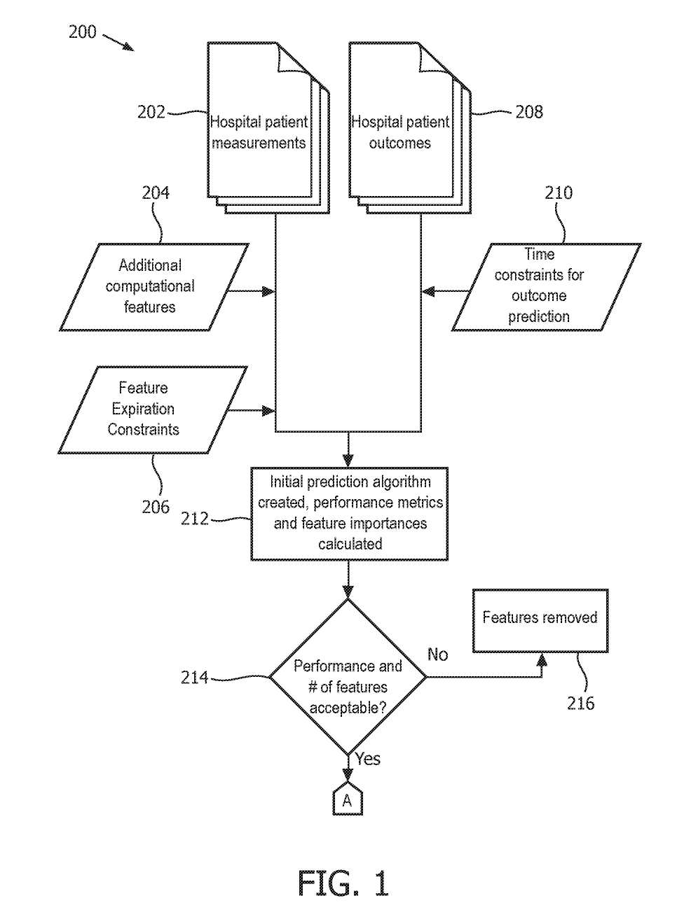

With reference to FIG. 1, a schematic illustrating a hospital and user input to a system 200 to create a custom event detection system tailored for a hospital's patient population and event interest is described. Hospitals are now increasingly capable of collecting large volumes of patient data, such as in a patient record database. The system 200 receives patient vital signs and other physiological measurements. The patient data generally includes a list of patient IDs, time stamps, and types of measurements 202, such as heart rate, systolic blood pressure, lab measurements and the like. Additional computational features 204 may also be added to the hospital patient data, e.g. combinations of features such as a shock index or trends. Feature expiration times 206 can also be input to the hospital patient measurement record 202, or are derived from the type of data. Depending on the collection site, different features may be considered valid for varying amounts of time. For example, a heart rate may be considered valid for up to an hour after which it is considered out of date and a new heart rate reading would be taken. In contrast, a lab value (e.g. white blood cell count) may be considered valid for 24 hours or more.

In addition to inputting hospital patient measurements 202, hospital patient outcomes 208 are entered. These include events the hospital is interested in predicting or detecting such as, for example, transfer to higher levels of care, mortality, fluid administration, recovery and discharge, or other events. Time constraints for outcome prediction or detection 210 may also be entered for some or all patient outcome types. The time constraints for prediction and detection 210 puts a time constraint on what types of predictions can be output. For example, for some types of events, notification of high probability of the event may be considered unactionable if the notification is too early (too far before event) or too late. In subsequent steps, this time range is used for algorithm development and performance evaluation.

The various inputs 202, 204, 206, 208, 210 are used to train a data-driven AWTTS system. In an illustrative approach, data from the patient physiological measurements 202, the additional computational features 204, feature expiration constraint times 206, the hospital patient outcomes 208, and the time constraints for outcome prediction 210 are combined into an “unstacked” data form. This data form is a table in which each row of the table corresponds to a time point, and each column contains a different feature type (e.g. heart rate), and each row is flagged with a true/false indication of whether that row corresponds to an event occurrence. This table is used to train an initial prediction algorithm 212 (e.g. using the Random Forests data mining technique, or another machine learning technique such as logistic regression, neural network training, or so forth), from which the importance of each feature is calculated, and an initial estimate of performance targets is computed.

After all inputs are added to the system, the initial prediction algorithm 212 along with performance metrics and feature importance is created. This information is presented to the user to review and determine if the performance and number of features are acceptable 214. The user is given the option to eliminate features 216 (this allows the algorithm to be deployed when fewer features are measured). If features are selected for elimination, the prediction algorithm training 212 is repeated to create a new algorithm with remaining features. This process iterates until user is satisfied with results or other prediction accuracy metrics are attained. The output of the process of FIG. 1 is a machine-learned Aggregate Weighted Track and Trigger System (AWTTS).

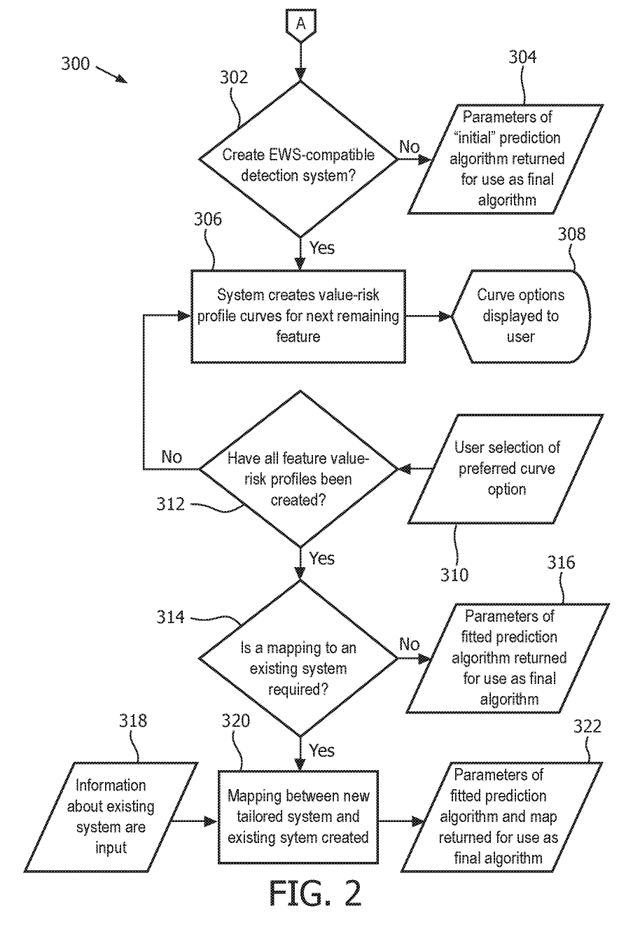

With reference to FIG. 2, a continuation schematic 300 illustrating a hospital and user input to a system to create a custom event detection system tailored for a hospital's patient population and event interest is described. At this point, the user may select the type of output system to generate an EWS-compatible detection system 302 look up table. An “initial” AWTTS algorithm produced by the operations described with reference to FIG. 1 may be a sufficient algorithm for prediction. If the user is satisfied with the initial prediction algorithm produced, then then it is assigned as a final AWTTS algorithm 304.

However, the AWTTS algorithm 304 is a machine learning output, and may not have readily recognized relationships with physiological parameters in a manner readily perceived by medical personnel. (By contrast, the illustrative MEWS system of Table 1 perceptibly associates a readily understood medical parameter such as heart rate with the MEWS score). For medical use, such a “black box” AWTTS may be undesirable. Accordingly, in some embodiments the AWTTS output by the operations of FIG. 1 are, in operation 306 and following of FIG. 2, converted to a more readily understood system. To generate a more readily understood AWTTS system, risk curves are created based upon the input. For example, in one embodiment, the Naive Bayes method may be used to generate risk curves to create a more readily understood AWTTS system. The features selected in steps 212 and 214 of FIG. 1 are used in step 306 of FIG. 2 to create possible feature value-risk curves. The curve-creation may be repeated on different subsets of available data to create error bars, showing the user the likely range of most appropriate value-risk curves. The created curves, along with raw data, and curves from existing literature (if available) are presented to the user in step 308. By default the system selects the curve with the best fit to the data and the best smoothness (e.g., measured by fractal dimension), but the user may use his/her medical knowledge to select a different curve, or may use a generated curve and manually modify sections of the curve 310. At a decision 312, if additional features or computed features (e.g. Shock Index) remain that should be profiled, then steps 306, 308, and 310 are repeated for each such feature. The resulting system may be used and deployed as the AWTTS for event detection, using a threshold specified by the optimal position on an ROC curve (to optimize sensitivity and specificity), or other defined threshold as a decision boundary.

The AWTTS output by steps 306-312 is more easily understood by medical personnel compared with the unprocessed machine learning output of FIG. 1. For example, medical personnel can readily comprehend the medical significance of the various value/risk profiles output by the operations 306-312. However, a further difficulty may arise, in that the AWTTS is different from the existing warning system (e.g. EWS or MEWS) employed by hospital personnel. To remedy this, if the machine-learned AWTTS is to replace an existing more heuristic detection system (e.g. MEWS), a mapping is optionally created between the new AWTTS and original warning system (e.g. MEWS).

Accordingly, in a step 314 the user is given the option to map the new AWTTS to a current (e.g. EWS) system to ensure easier use and adoption. If no mapping is requested, then the AWTTS output by the steps 306-312 is adopted as the final AWTTS 316. On the other hand, if in step 314 the user requests a mapping to the old (M)EWS system, then information on the existing system is input at step 318. The mapping between the current implemented EWS system and the new EWS system is created in step 320, and the final system is returned to user in the form of an executable program, or coefficients defining a new (or possibly hybrid, e.g. cross-mapped) AWTTS algorithm 322. If discretization is to be provided (e.g. to be hand-calculable, the AWTTS output may preferably be an integer value 0-5, or 0-10, etc.), discretization is performed. Algorithm and performance metrics are returned to user for deployment.

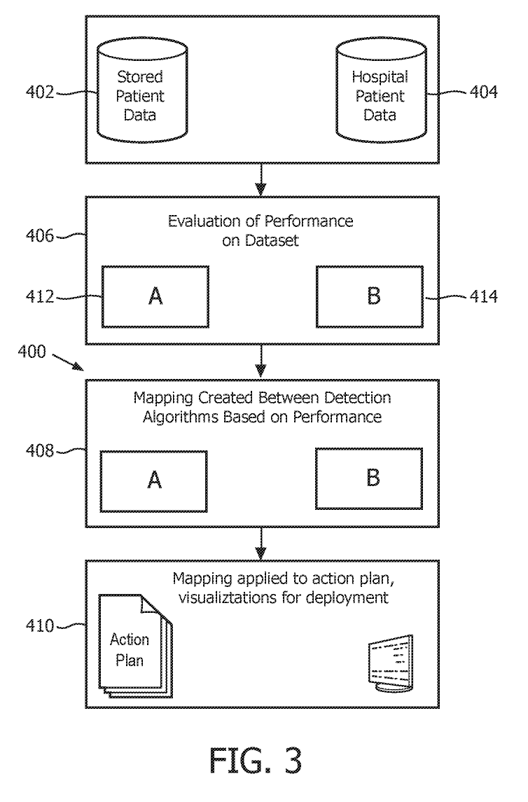

With reference to FIG. 3, a system 400 and technique for performing the mapping step 320 to create equivalent mappings between the new AWTTS system and the current EWS event detection system is illustrated. Without loss of generality, in FIG. 3 the existing EWS or other existing warning system is labeled Algorithm “A” 412, while the AWTTS generated by the steps of FIGS. 1 and 2 is labeled Algorithm “B” 414. A dataset is determined for evaluation. For initial deployment of the new Algorithm B, 414, existing datasets of patient data 402 are used to create mapping tables from the current EWS system A 412. For a tailored mapping, or in the absence of existing data, hospital-originated data 404 is used to create a custom mapping using the same procedures described below. The following uses the chosen dataset for performance evaluation 406. The dataset contains information of patient state (heart rate, blood pressure, etc.) and events (mortality, transfer, discharge, etc.). The output scores of an algorithm (A or B) are used as decision boundaries (predicting whether the event occurred according to that algorithm), and decisions based on these thresholds are characterized by performance metrics including sensitivity, specificity, and others. These performance metrics are calculated for each possible threshold of current EWS system A 412, and for each possible threshold of new AWTTS system B, 414.

Using these performance metrics, each EWS score action threshold of current EWS system A 412 (lefthand column of Table 1) is paired with an equivalent threshold of new AWTTS system B, 414, where equivalence can be defined in a variety of ways, some illustrative examples of which are described below. The output of this evaluation step 406 is a mapping 408 containing all of the thresholds of current EWS system A 412, and the corresponding thresholds of new EWS system B, 414. The mapping is applied to the existing EWS plan and to patient output modules for deployment 410.

In the step 410, the implemented system can be used in a variety of manners, depending on the goals of the hospital. In one approach, the mapping 408 can be used in real time to convert all scores from the new AWTTS system B, 414 into the equivalent current EWS system A 412 scores. Nurses and physicians are then presented with deterioration scores that they are accustomed to and trained with, and thus would be able to benefit from the performance improvements of new EWS system B, 414 without retraining. Likewise, the original action plan could be used without modification, because the score conversion is performed prior to looking up the appropriate action in the Action Plan (e.g. Table 1, right column). A possible disadvantage of this approach is that it is not transparent that the new AWTTS system is actually being used to trigger the actions.

To maximize transparency, the step 410 can instead translate the thresholds of the action plan from the current EWS system A 412 scores to the new AWTTS system B, 414 scores. In other words, the score thresholds in the lefthand column of Table 1 would be replaced by thresholds for the mapped scores of the AWTTS 414. Care providers would be presented directly with scores from the new AWTTS system B, 414, and would use the translated actions table to determine an appropriate response. This approach for implementing step 410 advantageously eliminates the effort to create a new action plan and is transparent about the new AWTTS system 414 being deployed.

In a compromise approach, both scores are provided. The mapping table could be used in real time as described above, but the new EWS system B, 414 and the current EWS system A 412 scores could be presented together in data displays. This would provide physicians the current EWS system A 412 scores they are trained with, as well as the new EWS system B, 414 scores that are being transitioned to. In effect, this adds an additional column to Table 1 containing the score thresholds for the new AWTTS system 414. Over time, the current EWS system A 412 scores could be discontinued as staff acceptance grows.

The implementation of the mapping step 408 depends upon the desired equivalence criteria to be employed. The datasets 402, 404 include tables of patient data, where each row of the table describes a patient state (vital signs, history, medications or other information), and optionally a flag indicating whether the patient deteriorated. When presented with a dataset, the step 406 calculates performance metrics of each possible threshold of the existing current EWS system A 412 and the new AWTTS system B, 414, and the mapping step 408 uses these metrics to relate equivalent scores and create the translation mapping. The particular equivalence definition can be selected based on the hospital needs (e.g. to reduce false positive rates, or to improve sensitivities).

For example, in sensitivity-based equivalence, each threshold of the current EWS system A 412 and the new AWTTS system B, 414 is evaluated for sensitivity in prediction of the target event. For each threshold from the current EWS system A 412, a threshold with minimum difference in sensitivity from the new AWTTS system B, 414 is determined to be its equivalent threshold. This definition allows the hospital to apply the performance enhancements of the new AWTTS system B, 414 to improve specificity and reduce false positive rates. This equivalence is especially well-suited for situations where a false positive could lead to costly or risky interventions applied to a well individual.

In specificity-based equivalence, each threshold of the current EWS system A 412 and the new EWS system B, 414 is evaluated for specificity in prediction of the target event. For each threshold from the current EWS system A 412, a threshold with minimum difference in specificity from the new AWTTS system B, 414 is determined to be its equivalent threshold. This definition allows the hospital to apply the performance enhancements of the new AWTTS system B, 414 to improve sensitivity and reduce false negative rates. This equivalence is especially well-suited for situations where there may be dramatic consequences of incorrectly assessing a patient as not likely to experience an outcome.

In positive-Predictive Value (PPV)-based and Negative-Predictive Value (NPV) equivalence, performance is calculated as in sensitivity-based equivalence and specificity-based equivalence discussed above, but event prevalence is also included in order to calculate the PPV or NPV of each threshold from the current EWS system A 412. This approach provides a balance of sensitivity and specificity that takes into account outcome prevalence and the cost or benefit of response. PPV and NPV more accurately account for this existing value assessment, and using them for equivalence allows a similar balance to be found in the new AWTTS system B, 414 scores that similarly weigh sensitivity and specificity, resulting in improvements in both.

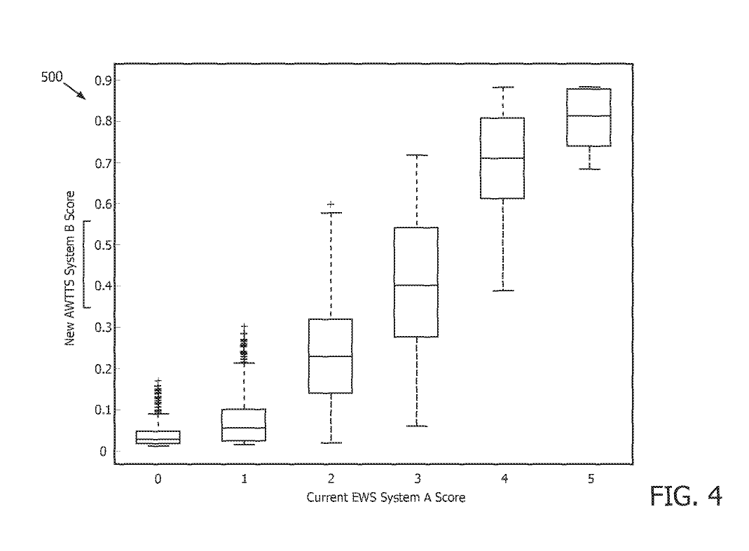

With reference to FIG. 4, in yet another approach, conditional probability equivalence is employed. Here, for each row of patient data, scores for the current EWS system A 412 and the new AWTTS system B, 414 are calculated. Each row of data that results in the current EWS system A 412 score may result in a range of new AWTTS system B, 414 scores, with some scores more likely than others. From this dataset and these distributions, each possible score of the new AWTTS system B, 414 is mapped to the current EWS system A 412. An inverse map is created by the converse: for each current EWS system A 412 score finding the new AWTTS system B, 414 score that maximizes the conditional probability P(Score B|Score A), where the new translated new AWTTS system B, 414 score is as close as possible to the older current EWS system A 412 score for the same patient state and mapped 500. This equivalence is especially well-suited to situations where consistency is important.

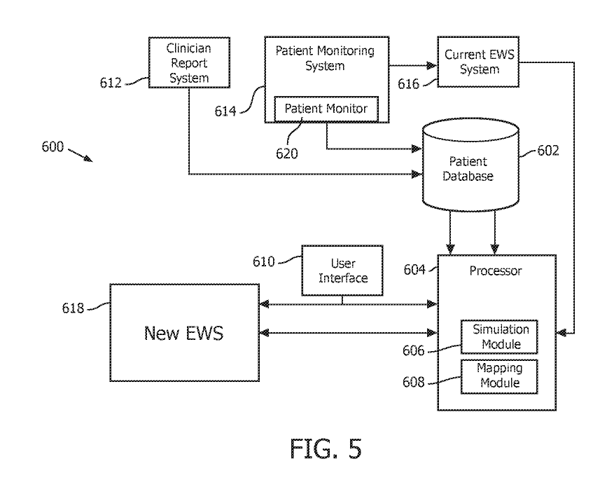

With reference to FIG. 5, the system for incorporating an improved Aggregate Weighted Track and Trigger System (AWTTS) into the existing early warning system (e.g. EWS) is illustrated. The system 600 includes a patient database 602, a user interface 610 (for example, including a display device and one or more user input devices such as a keyboard, mouse or other pointing device, touch screen, or so forth), a clinician report system 612, and a patient monitoring system 614, including one or more patient monitors 620 (e.g., an electrocardiograph and/or SpO₂ sensor to measure heart rate, a respiratory sensor, a blood pressure sensor, et cetera). The patient database 602 generally includes a list of patient IDs, time stamps, and types of measurements 202, such as heart rate, systolic blood pressure, lab measurements and the like for use as training data in the machine learning of an improved AWTTS algorithm. The system also includes at least one electronic data processing device (e.g. computer) including an electronic processor 604, which executes software to implement a simulation module 606, and a mapping module 608. The simulation module 606 receives input from the patient database 602, the clinician report system 612, and the patient monitoring system 614.

The simulation module 606 is used to train an initial prediction algorithm, for example in accord with a method such as those described with reference to FIGS. 1-3. The clinician report system 612 enables the user to input additional patient values, other preferences related to diagnosis and treatment from a patient's perspective, and combinations of features such as a shock index or trends for the new AWTTS algorithm which are used to select the new tailored AWTTS algorithm. The patient monitoring system 614 includes at least one patient monitor 620 attached to the patient. The patient monitor 620 tracks patient vital signs such as blood pressure, heart rate, SpO₂ saturation, and the like. The information received from the clinician report system 612 and the patient monitoring system 614 are input to the patient database, and an accumulated training set from a large number of such patients is used by the simulation and mapping modules 606, 608 to determine a new AWTTS algorithm.

During the patient monitoring phase, the AWTTS learned by the simulation module 606, and the existing EWS system 616 in embodiments using its output, are employed in conjunction with the mapping produced by the mapping module 608 and the actions table (e.g. an electronic version of Table 1 herein) to provide early warning of deterioration of a currently monitored patient.

The one or more processors 604 suitably execute computer executable instructions embodying the foregoing functionality, e.g. the simulation module 606 and mapping module 608. It is, however, contemplated that at least some of the foregoing functionality can be implemented in hardware without the use of processors. For example, analog circuitry can be employed. Even more, although the foregoing components of the patient care plan system 10 were discretely described, it is to be appreciated that the components can be combined.

The processing already described with reference to FIGS. 1-3 can be performed using the system of FIG. 5, for example in accord with the following. The information from the clinician report system 612 and the patient monitoring system 614 is combined into an “unstacked” data form. This data form is a table in which each row of the table corresponds to a time point, and each column contains a different feature type (e.g. heart rate), and each row is optionally flagged with a true/false indication of whether that row corresponds to an event occurrence. Upon generation of the data table, the simulation module 606 generates a new tailored candidate AWTTS algorithm, a profile curve based upon these user inputs, and performance of the new AWTTS algorithm. This information is then presented to the user on the user interface 610. After reviewing the candidate AWTTS algorithm the user can provide feedback to the simulation module 606 to add or remove additional features or constraints contained in the patient database such as time constraints for prediction outcome. The simulation module 606 then simulates a new candidate AWTTS algorithm based upon the user input. The simulation module 606 continues to simulate new tailored candidate AWTTS algorithms in this manner until the user is satisfied with the resulting algorithm. When the simulation module 606 has generated a new tailored AWTTS algorithm acceptable to the user, the new AWTTS algorithm is sent to the mapping module 608.

The mapping module 608 takes the new tailored AWTTS algorithm and maps it to the existing EWS algorithm 616 currently implemented. The mapping module 608 receives the information from the simulation module 606 and maps the new AWTTS system to the current system and outputs the results to the user interface 610. The mapping module 608 uses the new AWTTS algorithm and performance metrics calculated by the simulation module 606 and pairs each performance threshold metric of the current EWS algorithm 616 to an equivalent threshold of the new AWTTS algorithm. The paired equivalent thresholds are applied to the current EWS algorithm and implemented for use on the patient monitoring system 614.

The implemented system can be used in a variety of manners, depending on the goals of the hospital, e.g. mapping scores of the new AWTTS to the old EWS system 616 so that the original actions table (e.g. Table 1) can be used in unmodified form; or, updating the score action thresholds column (left hand column of Table 1) to the mapped AWTTS scores; or, a combination of these approaches (e.g. adding a new column to Table 1 presenting the mapped AWTTS score thresholds).

It will be further appreciated that the disclosed techniques can be embodied as a non-transitory storage medium storing instructions readable and executable by a computer to perform the disclosed techniques. The non-transitory storage medium may, for example, include a hard disk drive or other magnetic storage medium, an optical disk or other optical storage medium, a flash memory or other electronic storage medium, or so forth.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. An early warning system for patient monitoring, the early warning system comprising:
one or more patient monitors configured to generate patient physiological data;
a patient database storing patient physiological measurements and outcomes; and
one or more computer processors programmed to:
machine learn an Aggregate Weighted Track and Trigger System (AWTTS) algorithm for quantifying patient condition by an AWTTS score based on a training set of the patient physiological measurements and outcomes;
apply an Early Warning Score or Modified Early Warning Score (EWS) algorithm to patient physiological measurements to generate EWS scores;
apply the machine-learned AWTTS algorithm to the patient physiological data acquired by the one or more patient monitors for a current patient to generate an AWTTS score for the current patient;
create a mapping between the AWTTS scores and the EWS scores; and
apply the mapping to convert the AWTSS score for the current patient to an EWS score for the current patient.

2. (canceled)

3. The early warning system according to claim 1, the one or more computer processors further configured to:
apply the mapping to convert EWS score thresholds of an EWS score-Action Trigger table correlating EWS score thresholds with action triggers to generate an AWTTS score-Action Trigger table correlating AWTTS score thresholds with action triggers;
apply the machine-learned AWTTS algorithm to patient physiological data acquired by the one or more patient monitors for a current patient to generate an AWTTS score for the current patient; and
display the AWTTS score for the current patient on a user interface.

4. The early warning system according to claim 1, wherein the machine learned AWTTS algorithm operates on:
feature expiration time constraints for physiological measurements; and
time constraints for outcome prediction.

5. The early warning system according to claim 1, wherein the one or more processors is further configured to:
generate a value-risk curve from user selected features;
display the value-risk curve on a user interface of the patient monitoring system showing the likely range of most appropriate value-risk; and
receive a selection of a preferred value-risk curve via the user interface.

6. The early warning system according to claim 1, wherein the mapping between the AWTTS algorithm scores and the EWS scores is created by operations including:
applying the EWS algorithm to generate EWS scores for patients with known outcomes to generate an EWS evaluation dataset;
applying the machine learned AWTTS algorithm to generate AWTTS scores for the patients with known outcomes to generate an AWTTS evaluation dataset; and
creating the mapping to align EWS score action thresholds in the EWS evaluation dataset with equivalent AWTTS scores in the AWTTS evaluation dataset.

7. The early warning system according to claim 6 wherein EWS score-AWTTS score equivalence is a sensitivity-based equivalence.

8. The early warning system according to claim 6 wherein EWS score-AWTTS score equivalence is a specificity-based equivalence.

9. The early warning system according to claim 6 wherein EWS score-AWTTS score equivalence includes a statistical predictive value-based equivalence computed based on outcome prevalence.

10. The early warning system according to claim 6 wherein EWS score-AWTTS score equivalence is a conditional probability equivalence that maximizes the conditional probability P(AWTTS score|EWS score).

11. An early warning method for patient monitoring, the early warning method comprising:
applying an Early Warning Score or Modified Early Warning Score (EWS) algorithm to patient physiological measurements to generate EWS scores quantifying patient condition;
applying an Aggregate Weighted Track and Trigger System (AWTTS) algorithm to the patient physiological measurements to generate AWTTS scores quantifying patient condition;
wherein the applying operations and the creating operation are performed by an electronic data processing device;
creating a mapping between the AWTTS scores and the EWS scores;
apply the mapping to convert the AWTTS score for a current patient to an EWS score for the current patient; and
displaying the EWS score for the current patient on a display device.

12. (canceled)

13. The early warning method of claim 11 further comprising:
applying the mapping to convert EWS score thresholds of an EWS score-Action Trigger table correlating EWS score thresholds with action triggers to generate an AWTTS score-Action Trigger table correlating AWTTS score thresholds with action triggers;
applying the AWTTS algorithm to patient physiological data for a current patient to generate an AWTTS score for the current patient; and
displaying the AWTTS score for the current patient.

14. The early warning method of claim 11, wherein the mapping comprises:
mapping to align AWTTS scores and EWS scores for patients whose EWS scores are at action thresholds as defined by an EWS score-Action Trigger table correlating EWS score thresholds with action triggers.

15. The early warning method of claim 14, wherein the alignment of AWTTS scores and EWS scores maximizes at least one of: sensitivity-based equivalence; specificity-based equivalence; positive-predictive value-based equivalence; negative-predictive value-based equivalence; and conditional probability equivalence P(AWTTS score|EWS score).

16. The early warning method of claim 11, further comprising:
generating the AWTTS algorithm by performing machine learning on a training set of the patient physiological measurements and outcomes.

17. (canceled)

18. (canceled)

19. (canceled)

20. (canceled)
